(19) United States
(12) Patent Application Publication
(10) Pub. No.: US 2023/0397699 A1
(43) Pub. Date: Dec. 14, 2023

(54) CAR SEAT BELT RELEASE DEVICE

(71) Applicants: Hubert Hektus, Warszawa (PL); Mateusz Wisniewski, Otwock (PL); Maciej Malecki, Grojec (PL)

(72) Inventors: Hubert Hektus, Warszawa (PL); Mateusz Wisniewski, Otwock (PL); Maciej Malecki, Grojec (PL)

(21) Appl. No.: 18/032,229

(22) PCT Filed: Oct. 26, 2021
(86) PCT No.: PCT/IB2021/059868

§ 371 Date: Apr. 17, 2023

(30) Foreign Application Priority Data
Oct. 27, 2020 (PL) PL435789

(51) Int. Cl. A44B 11/26; B60R 22/32

(52) U.S. Cl. CPC A44B 11/26; B60R 22/32

(57) ABSTRACT

An locking/unlocking device for a car seat belt that enables the driver and the passengers to get released from its operation in a situation of occurrence of a sudden event. The car seat belt release device has a clasp element and a body, releasably interconnected, and one of the two has slots and a channel, while the other one of the two has a base and a core, in the middle of which a shank opening is arranged, and shoulders at its both sides. When the body is assembled with the clasp element, in through holes with bolt recesses, as well as in locking openings with bolt tunnels, locking pins with bolts are positioned, wherein each bolt is maintained within a bolt ledge, causing thus pressing of a compression spring in a bottom section of the locking opening.

The object of the invention is a car seat belt release device that enables the driver and the passengers release its operation in a situation of occurrence of a sudden event, e.g., a car accident or a breakdown that cause a necessity to leave the car which needs to be preceded by releasing the person from the seat belt, when it is impossible to have it conventionally disconnected (unfastened).

A car seat belt mounted in a car allows for tight securing of the user to the safety cage of the vehicle. As a result, in the case of a road collision, at a relatively low velocity, e.g. 50 km per hour, human body is ejected from the car seat with a force of about 2.5 tons, and as a result, if the driver or a passenger have no fastened belts, they will surely be seriously injured, including even death, in such situations.

Nevertheless, sometimes, in an unexpected road event, there may arise a necessity to leave quickly the vehicle, e.g. when a risk of fire is involved. Situations are known when a fastened seat belt upon collision of the vehicle cannot be unfastened, and thus the user becomes trapped within the vehicle. Occurrence of such circumstances involves a serious threat to the user's health and life.

In the prior art, several solutions were developed that are intended to release thus trapped user of the road.

Blades and knives are known that enable emergency cutting of the belt by the user himself/herself or by another person, for example the one who is helping to release the user from the interior of the car in the case of collision, fire, breakdown or falling into water.

For example, Polish invention no. PL 173157 is known the subject-matter of which provides a seat knife, in particular for cutting seat belts, consisting of a blade of a constant cutting angle secured in a holder with an oblique cutting slot and a quick release coupling that secures the assembly. Another known solution of this kind is presented in the patent specification no. U.S. Pat. No. 4,009,905. According to the solution seat belt is provided with an additional device intended to be used in dangerous situations in order to release the user from the seat belt. The device is provided with a pair of parallel blades and one of them may be pulled along the other, to cut the belt with a cut similar as the one obtained by shearing.

In the prior art there are also solutions that comprise mechanisms of various kinds, intended for unfastening or separating of the seat belt, without use of any tools with a blade for cutting the belt.

An example is disclosed in the European Patent no. EP 0318376, where division of the hip part of the seat belt into two parts is proposed. In this solution the seat belt comprises a main hip part and an extension part. The main hip part and the extension part are interconnected by connecting inserts. The inserts are formed of portions of each of the ends of the seat belt and have a form of a loop. Loops at the ends of the main hip part and the extension part are alternately slid over the connecting pin. The connecting pin extends thus transversely to the length of the seat belt and it is the connecting element that connects the main hip part with the extension part. The connecting pin has two outer flanges to prevent the loop from sliding off. The pin is set of two parts that may be slid apart. Sliding apart of the parts of the pin, and resulting unfastening of the two parts of the seat belt, is possible upon breaking a string that connects the flanges of the two parts of the connecting pin.

In turn, French invention no. FR 2398513 discloses a system of seat belts provided with an emergency device that automatically releases the seat belt from its fastener when a fire occurs within the car or the car falls into water. In this solution to the car body an electromagnet is screwed that is connected to a battery. Wiring in this solution has several heat, smoke and humidity sensors. In the case of fire or when the car is in water, a signal from the corresponding sensor is provided to the controller in order to unlock the belt.

German invention no. DE 2740361 encompasses a mechanism intended for automatic unfastening of the car user from the seat belt upon an accident. The mechanism is used with three-point seat belts with a fastener in one anchoring points where the belt forms a loop. The device is comprised of a cylindrical housing inside which a slider element is seated that moves against the force of springs. A piston is provided with channels for tightening of the belt loop and it also comprises a blade. Upon accident, sudden pulling of the belt forces the piston forward towards the spring that begins acting on a threaded plug and presses it with an increasing velocity against the rear end of the blade to press the belt loop and cut it.

The solution according to the invention constitutes a response to the increasing market demand that requires a solution that provides both expedite locking of the belt, and thus for the use during driving, as well as for unlocking in emergency situations due to an external cause, but without any necessity to use sharp tools, and thus a device that might be used several times.

The subject-matter of the invention is a device that releases a car seat belt and is characterized in that it comprises a clasp element and a body that are releasably inter-connected, where one of the two comprises slots and a channel within which a closing pin is arranged and at least one locking opening, the locking opening comprising at least one bolt tunnel terminating in at least one bolt ledge positioned perpendicularly thereto, and the other one of the two comprises a base, provided with at least one through hole with at least one bolt recess, and a core inside of which a pin opening is positioned and shoulders at its two sides. At the same time, when the body is assembled with the clasp element, in at least one through hole with at least one bolt recess, and in at least one locking opening with at least one bolt tunnel, at least one movable pin is arranged provided with a compression spring and at least one lock, where the lock is maintained in a lock ledge and thus causes pressing of the compression spring in the bottom section of the locking opening.

Preferably, at the top of the body there are at least two locking openings and the base is provided with at least one through hole, and between the through holes with bolt recesses a cores is positioned.

Preferably, at the top of the locking pin there is a locking element.

Preferably, at the top of the locking pin there is a cut.

Preferably, at the top of the locking pin there is a pulling feature.

In order to use of the solution of the invention, the clasp should be oriented towards the closure secured to the inside of the car and push it inward, and thus perform a standard process for closing a seat belt.

Then, the pin secured in each of the locked openings should be pressed inside and gently turned to one or other side with one finger. This motion causes the bolt slide into the bolt ledge and at the same time pressing of the compression spring. In this manner the body becomes secured to the clasp element, and thus the seat belt becomes locked. Presence of a cut or a pulling feature at the top of the pin facilitates turning it.

In order to effect quick unfastening of the belt, a reverse process should be performed, which is, with one finger the pin should be moved to one or the other side (with the use of a cut or a pulling feature), until the bolt slides out the bolt ledge and seats in the bolt channel. As a result the compression spring will automatically push the pin out from the locking opening and the through hole to the outside. In this manner the body becomes disconnected from the clasp element, and thus the seat belt becomes unlocked to enable the passenger to set free from the vehicle.

The invention in an embodiment is presented in more detail in the drawings.

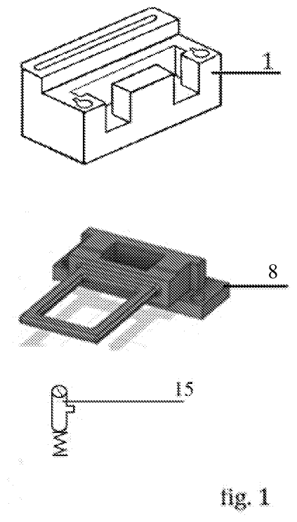

FIG. 1 presents the solution in all the three separate parts in the perspective view. The following may be seen: a body 1, a clasp element 8 and a movable pin 15. All the parts presented in this figure form a locking/unlocking device for a car seat belt.

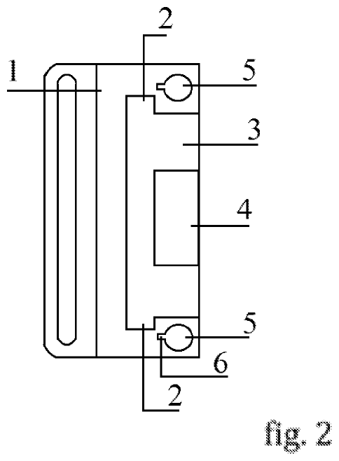

FIG. 2 shows visually in more detail the solution and discloses a body 1 also in a top view. The body 1 is provided with a channel 2 comprising slots 2. Inside the channel 3 a closing shank 4 is arranged. Two locking openings 5 at the top of the body 1 may be seen. Each locking opening 5 has a bolt tunnel 6 therein.

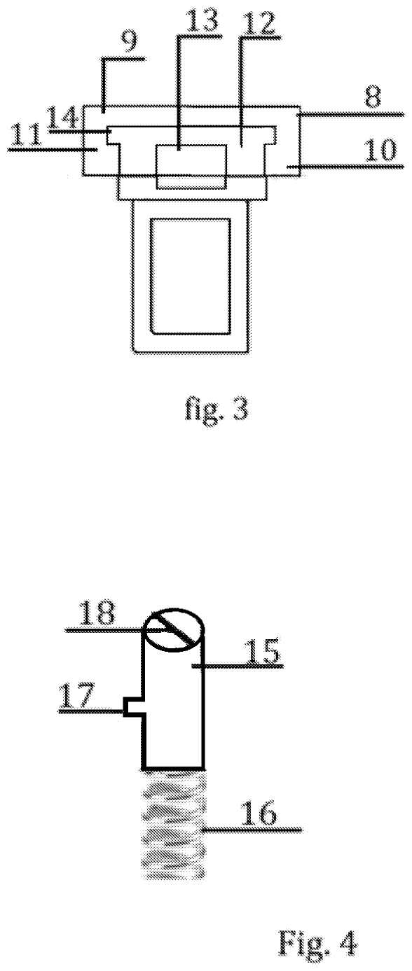

FIG. 3 is also a top view, but of the clasp element 8. As shown, the clasp element 8 has a base 9, provided with two through holes 10 with bolt recesses 11. Between two through holes 10 with bolt recesses 11 a core 12 is positioned within which a rectangular shank opening 13 is arranged, and shoulders 14 arranged at its both sides.

FIG. 4 is a side view of the third element of the invention, which is a pin 15 that is provided with a compression spring 16 and a bolt 17. At the top of the pin 15 a cut 18 is shown.

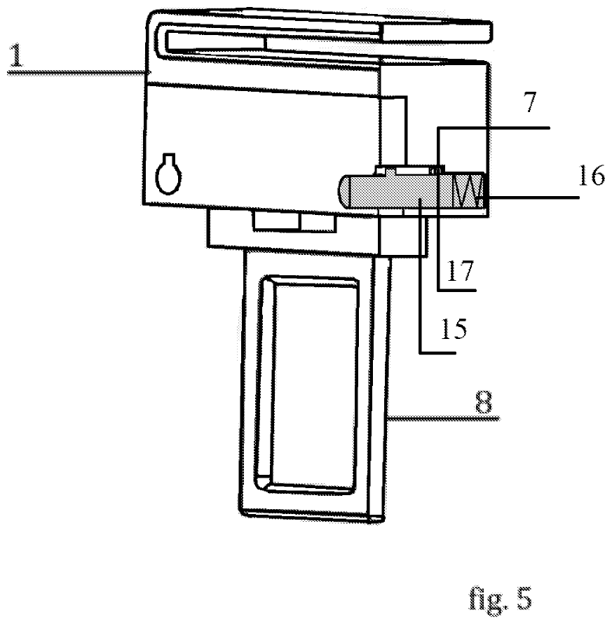

FIG. 5 is a cross-section of the entire solution when assembled. The body 1, the clasp element 8 and the pin 15 are in this figure in an closed position. The compression spring 16 is in its pressed state. A bolt ledge 7 is marked in which a bolt 17 is provided. A component of the pin 15 being the compression spring 16 becomes pressed and this causes stable maintaining of the pin 15 within the construction, and thus stable maintaining of the entire solution in a closed position.

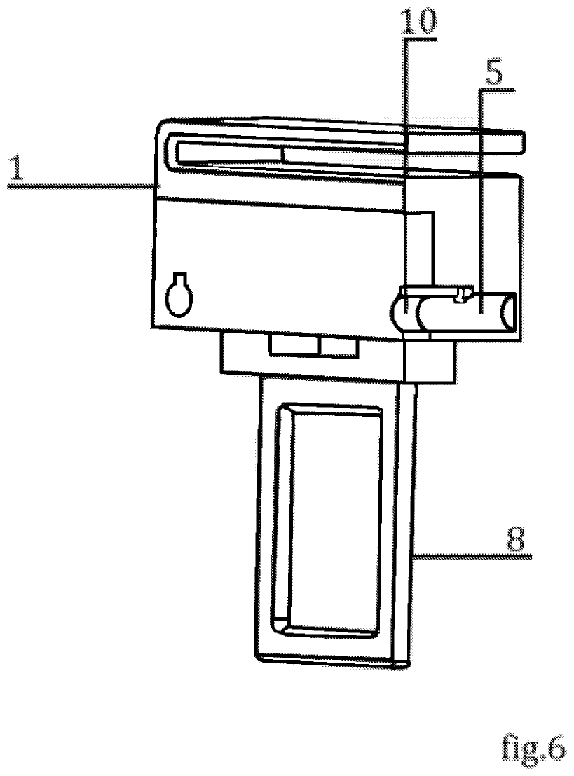

FIG. 6 presents also a cross-section of the entire solution when assembled, where the body 1 and the clasp element 8 may be seen, but in a situation when the pin has been slid out of the locking openings 5 and through holes 10. Removal of the pin from the locking opening 5 and the through hole 10 causes opening of the entire construction.

In another embodiment, not shown in the drawing, in lieu of the cut a pulling feature is provided.

The solution of the invention will be applicable in practice in any vehicle, without need for carrying out any special mounting work.

Car seat belt locking/unlocking device is an alternative for the existing solutions and allows for quick release of both the driver and the passengers from their seat belts in a situation of occurrence of a sudden event, e.g. collision, fire, breakdown or falling into water when it is necessary to leave the car and when standard unfastening of the seat belt is not possible.

1-5. (canceled)

6. A car seat belt release device comprising a clasp element and a body releasably interconnected, and one of the two comprises slots and a channel, within which a closing pin is arranged, and at least one locking opening, and a locking opening has at least one bolt tunnel terminating in at least one bolt ledge positioned perpendicularly thereto, while the other one of the two comprises a base, provided with at least one through hole with at least one bolt recess, and a core within which a shank opening is arranged, and shoulders at its sides, while when the body is assembled with a clasp element in at least one through hole with at least one bolt recess and at least on one locking opening with at least one bolt tunnel, at least one movable locking pin is arranged provided with a compression spring and at least one bolt, wherein the bolt is maintained within the bolt ledge causing pressing the compression spring in a bottom section of the locking opening.

7. The device of claim 1 wherein at the top of the body there are at least two locking openings and the base is provided with at least two through holes, and between the through holes with bolt recesses a core is arranged.

8. The device of claim 1 wherein at the top of the locking pin there is a locking element.

9. The device of claim 1 wherein at the top of the locking pin there is a cut.

10. The device of claim 1 wherein at the top of the locking pin there is a pulling feature.
